(19) United States
(12) Patent Application Publication
(10) Pub. No.: US 2022/0016601 A1
(43) Pub. Date: Jan. 20, 2022

(54) EXHAUST-GAS PURIFICATION APPARATUS AND METHOD FOR MANUFACTURING SAME

(71) Applicants: CATALER CORPORATION, Kakegawa-shi, Shizuoka (JP); TOYOTA JIDOSHA KABUSHIKI KAISHA, Toyota-shi, Aichi (JP)

(72) Inventors: Shunsuke OHISHI, Kakegawa-shi (JP); Takaya OTA, Kakegawa-shi (JP); Ryosuke TAKASU, Kakegawa-shi (JP); Mitsuyoshi OKADA, Kakegawa-shi (JP); Minoru ITOU, Kakegawa-shi (JP); Kana IWATA, Kakegawa-shi (JP); Takumi TOJO, Miyoshi-shi (JP); Takeru YOSHIDA, Miyoshi-shi (JP); Masaru KAKINOHANA, Toyota-shi (JP); Hiromasa SUZUKI, Toyota-shi (JP)

(73) Assignees: CATALER CORPORATION, Kakegawa-shi, Shizuoka (JP); TOYOTA JIDOSHA KABUSHIKI KAISHA, Toyota-shi, Aichi (JP)

(21) Appl. No.: 17/295,683

(22) PCT Filed: Nov. 14, 2019
(86) PCT No.: PCT/JP2019/044764

§ 371 Date: May 20, 2021

(30) Foreign Application Priority Data
Nov. 21, 2018 (JP) 2018-218615
May 7, 2019 (JP) 2019-087527

(51) Int. Cl. B01J 23/46; B01D 53/94; B01J 23/10; B01J 35/04; B01J 37/02; B01J 37/04; B01J 37/08

(52) U.S. Cl. CPC B01J 23/464; B01D 53/94; B01J 23/10; B01J 35/04; B01J 37/0215; B01J 37/04; F01N 3/2803; B01D 2255/1023; B01D 2255/1025; B01D 2255/9155; B01D 2255/9205; B01D 2255/905; B01J 37/082

(57) ABSTRACT

An exhaust-gas purification apparatus includes: a honeycomb base material including a plurality of exhaust-gas flow paths partitioned by a porous wall; and one or more catalyst noble metals carried by the honeycomb base material. The catalyst noble metals are selected from the group consisting of platinum, palladium, and rhodium. The honeycomb base material has a noble metal concentrated surface section in which a 50%-by-mass noble metal carry depth for a specific noble metal that is one type among one or two catalyst noble metals is less than 50% of the distance from the surface to the center of the inside of the porous wall. The 50%-by-mass noble metal carry depth is the depth at which, when the amount of the specific noble metal carried between the surface and the center of the inside of porous wall is used as a reference, 50% by mass of specific noble metal is carried.

### FIELD

The present invention relates to an exhaust gas purification device and a method for the production thereof.

### BACKGROUND

In general, in exhaust gas purification devices, a catalyst layer is formed on a honeycomb substrate composed of cordierite. The catalyst layer contains noble metal catalyst particles, carrier particles which carry the noble metal catalyst particles, and co-catalyst particles. The use of a ceria-zirconia composite oxide having an oxygen storage capacity (OSC) as one of the co-catalyst particles is known.

In recent years, the use of ceria-zirconia composite oxide particles as one of the constituent materials of the honeycomb substrate, not as the co-catalyst particles in the catalyst layer, has been examined. For example, Patent Literature 1 discloses an exhaust gas purification device in which the honeycomb substrate contains ceria-zirconia composite oxide particles. There is no catalyst layer in this exhaust gas purification device, and the noble metal catalyst particles are directly adhered to the honeycomb substrate by impregnating the honeycomb substrate with a solution containing the noble metal. Since such an exhaust gas purification device does not have a catalyst layer, it has a small heat capacity, whereby the temperature of the honeycomb substrate can easily rise, and high warm-up performance can be obtained.

Such honeycomb substrates and exhaust gas purification devices are also disclosed in Patent Literature 2 and 3.

It should be noted that general coating methods for forming a catalyst layer on a honeycomb substrate composed of cordierite are known as described in Patent Literature 4 and 5.

### CITATION LIST

### Patent Literature

[PTL 1] Japanese Unexamined Patent Publication (Kokai) No. 2015-85241

[PTL 2] Japanese Unexamined Patent Publication (Kokai) No. 2015-77543

[PTL 3] Japanese Unexamined Patent Publication (Kokai) No. 2016-34781

[PTL 4] Japanese Unexamined Patent Publication (Kokai) No. 2008-302304

[PTL 5] WO 2010/114132

### SUMMARY

### Technical Problem

The object of the present invention is to provide an exhaust gas purification device which has a high exhaust gas purification performance and which uses a honeycomb substrate containing ceria-zirconia composite oxide particles as a constituent material.

### Solution to Problem

The present inventors have discovered that the above object can be achieved by the present invention including the following aspects.

### <<Aspect 1>>

An exhaust gas purification device comprising a honeycomb substrate having a plurality of exhaust gas flow paths separated by a porous wall, and one or more catalyst noble metals which are carried by the honeycomb substrate, wherein

the honeycomb substrate includes ceria-zirconia composite oxide particles as a constituent material,

the catalyst noble metals are selected from the group consisting of platinum, palladium, and rhodium,

the honeycomb substrate has:

a noble metal-enriched surface part in which a 50 mass % noble metal carrying depth of a specific noble metal, which is one of the one or more catalyst noble metals, is less than 50% of the distance from a surface of the porous wall to a center of an interior of the porous wall, and

the 50 mass % noble metal carrying depth is a depth in which 50 mass % of the specific noble metal is carried based on a quantity of the specific noble metal carried from the surface of the porous wall to the center of the interior of the porous wall.

### <<Aspect 2>>

The exhaust gas purification device according to Aspect 1, wherein the specific noble metal is platinum or palladium.

### <<Aspect 3>>

The exhaust gas purification device according to Aspect 2, wherein

the specific noble metal is platinum or palladium, and

the catalyst noble metals include rhodium.

### <<Aspect 4>>

The exhaust gas purification device according to any one of Aspects 1 to 3, wherein the honeycomb substrate is constituted by an inlet-side part which is 60% or less of a total length of the honeycomb substrate from an inlet side of the exhaust gas flow path, and a main part constituting the remainder of the honeycomb substrate, and the noble metal-enriched surface part is present at least in the main part.

### <<Aspect 5>>

The exhaust gas purification device according to Aspect 4, wherein a length of the inlet-side part constituting the honeycomb substrate is 10% or more of the total length of the honeycomb substrate.

### <<Aspect 6>>

The exhaust gas purification device according to any one of Aspects 1 to 5, wherein the honeycomb substrate is constituted by an inlet-side part which is 30 mm or less from an inlet side of the exhaust gas flow path and a main part constituting the remainder of the honeycomb substrate, and the noble metal-enriched surface part is present at least in the main part.

### <<Aspect 7>>

The exhaust gas purification device according to Aspect 6, wherein a length of the inlet-side part constituting the honeycomb substrate is 10 mm or more.

### <<Aspect 8>>

The exhaust gas purification device according to any one of Aspects 4 to 7, wherein a quantity of the specific noble metal carried by the inlet-side part of the honeycomb substrate is greater than a quantity of the specific noble metal carried by the main part.

### <<Aspect 9>>s

The exhaust gas purification device according to any one of Aspects 4 to 8, wherein in the inlet-side part of the honeycomb substrate, the 50 mass % noble metal carrying depth of the specific noble metal is greater than the 50 mass % noble metal carrying depth of the specific noble metal of the main part.

### <<Aspect 10>>

The exhaust gas purification device according to any one of Aspects 1 to 9, wherein a porosity of the honeycomb substrate is 30% to 70%.

### <<Aspect 11>>

The exhaust gas purification device according to any one of Aspects 1 to 10, wherein at least a part of the exhaust gas flow path does not have a catalyst layer.

### <<Aspect 12>>

A method for the production of an exhaust gas purification device, comprising at least the following (a) to (c):

(a) supplying a solution containing salts of one or more catalyst noble metals and a thickening agent from one open side of a honeycomb substrate having a plurality of exhaust gas flow paths separated by a porous wall, the solution having a viscosity of 10 to 400 mPa at a shear rate of 380 s⁻¹ and the catalyst noble metals being selected from the group consisting of platinum, palladium, and rhodium;

(b) suctioning the supplied solution from an opening side of the honeycomb substrate opposite the side to which the solution was supplied and/or pumping the supplied solution from the opening side of the honeycomb substrate to which the solution was supplied; and

(c) drying and/or firing the honeycomb substrate.

### <<Aspect 13>>

The method according to Aspect 12, further comprising the following (d):

(d) immersing the honeycomb substrate in a solution containing salts of the catalyst noble metals so that at least a part of an inlet-side part which is 30 mm or less of a total length from an inlet of the exhaust gas flow path of the honeycomb substrate is immersed, and subsequently drying and/or firing the honeycomb substrate, whereby a quantity of the catalyst noble metal carried by the inlet-side part is greater than a quantity of the catalyst noble metal carried by a main part excluding the inlet-side part.

### BRIEF DESCRIPTION OF DRAWINGS

FIG. 1(a) is a perspective view schematically illustrating an aspect of the exhaust gas purification device of the present invention. FIG. 1(b) is a cross-sectional side view schematically illustrating an aspect of the exhaust gas purification device of the present invention.

FIG. 2 is a view schematically illustrating a porous wall of a honeycomb substrate of the exhaust gas purification device of the present invention in an enlarged manner.

### DESCRIPTION OF EMBODIMENTS

### <<Exhaust Gas Purification Device>>

The exhaust gas purification device of the present invention comprises a honeycomb substrate having a plurality of exhaust gas flow paths separated by a porous wall, and one or more catalyst noble metals which are carried by the honeycomb substrate.

The catalyst noble metal in the exhaust gas purification device of the present invention may be a platinum group element, and specifically, may be one or more selected from the group consisting of, for example, platinum, palladium, and rhodium. The catalyst noble metal in the present invention may be a noble metal containing platinum and/or palladium, may be a noble metal containing platinum or palladium, and may be a noble metal containing platinum and/or palladium and rhodium, and in particular, may be a noble metal containing platinum or palladium and rhodium.

The honeycomb substrate of the exhaust gas purification device of the present invention contains:

ceria-zirconia composite oxide particles as a constituent material, and

a noble metal-enriched surface part in which a 50 mass % noble metal carrying depth of a specific noble metal, which is one of the one or more catalyst noble metals, is less than 50% of the distance from the surface of the porous wall to the center of the interior of the porous wall.

The present inventors investigated carrying the noble metal catalyst particles on a honeycomb substrate containing ceria-zirconia composite oxide particles as a constituent material, and have discovered that by adjusting the viscosity of the solution containing a salt of the catalyst noble metal and applying it to the honeycomb substrate, the depth from the substrate surface on which these catalyst noble metal particles are carried changes. Conversely, as a result of investigation by the present inventors, it was discovered that in the method described in Patent Literature 1, i.e., in a method in which palladium is carried by a honeycomb substrate as a result of immersing the honeycomb substrate in, for example, a solution of a palladium salt, the palladium is carried uniformly through to the interior of the honeycomb substrate.

The present inventors have discovered that by adjusting the viscosity of the solution containing the catalyst noble metal salt, the catalyst noble metal is carried near the surfaces of the exhaust gas flow paths of the substrate at a high concentration, whereby the purification rate of the exhaust gas purification device can be increased. This is believed to be because the high concentration of the catalyst noble metal on the surfaces of the exhaust gas flow paths increases the likelihood of contact between the exhaust gas and the catalyst noble metal.

In the present invention, it is necessary that the honeycomb substrate have a noble metal-enriched surface part in which a 50 mass % noble metal carrying depth of a specific noble metal, which is one of the one or more catalyst noble metals, is less than 50% of the distance from the surface of the porous wall to the center of the interior of the porous wall.

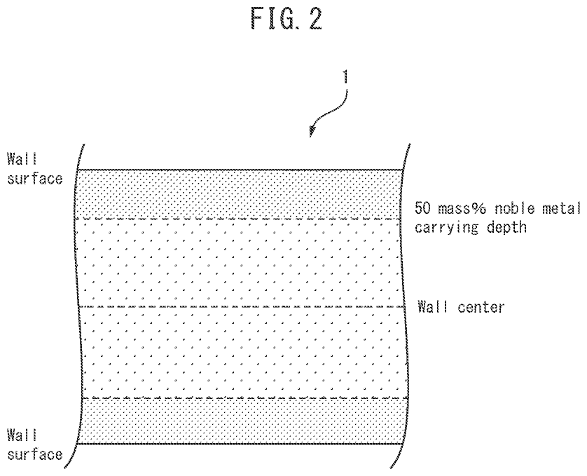

As used herein, “50 mass % noble metal carrying depth” means a depth in which 50 mass % of the specific noble metal is carried based on a quantity of the specific noble metal carried from the surface of the porous wall to the center of the interior of the porous wall at an arbitrary position. As shown in FIG. 2, the 50 mass % noble metal carrying depth is present from the surface of the porous wall to the center of the wall. When the specific noble metal is carried at a completely uniform concentration in the depth direction of the porous wall, the 50 mass % noble metal carrying depth is the depth of an intermediate position between the surface of the porous wall and the center of the wall. The fact that the 50 mass % noble metal carrying depth is less than 50% of the distance from the surface of the wall to the center of the wall (i.e., less than 25% of the wall thickness) means that more specific noble metal is carried by the surface side of the porous wall.

In the noble metal-enriched surface part, the 50 mass % noble metal carrying depth of the specific noble metal may be less than 50%, 46% or less, 40% or less, 35% or less, 30% or less, or 25% or less of the distance from the surface of the porous wall to the center of the interior of the porous wall. Expressing these numerical values in terms of the thickness of the porous wall, in the noble metal-enriched surface part, the 50 mass % noble metal carrying depth of the specific noble metal may be less than 25%, 23% or less, 20% or less, 17.5% or less, 15% or less, or 12.5% or less of the thickness of the porous wall. Specifically, in the noble metal-enriched surface part, the 50 mass % noble metal carrying depth of the specific noble metal may be, on average, 25 μm or less, 22.5 μm or less, 20 μm or less, 17.5 μm or less, 15 μm or less, 12.5 μm or less, or 10 μm or less.

In the noble metal-enriched surface part, the 50 mass % noble metal carrying depth of the specific noble metal can be the average value of three or more positions.

The noble metal-enriched surface part may be present across the entirety of the exhaust gas flow paths of the honeycomb substrate, or may be present in a portion thereof. For example, the noble metal-enriched surface part may extend across a length of 1/10 or more, ⅕ or more, ⅓ or more, ½ or more, or ⅔ or more of the total length of the exhaust gas flow paths of the honeycomb substrate, and may extend across a length of ⅔ or less, ½ or less, ⅓ or less, ⅕ or less, or 1/10 or less.

When the portion from the inlet side of the exhaust gas flow paths of the honeycomb substrate to a predetermined length is defined as an inlet-side part of the honeycomb substrate and the portion excluding that portion is defined as a main part of the honeycomb substrate, the noble metal-enriched surface part is preferably present at least in the main part. The length of the inlet-side part of the honeycomb substrate may be 10% or more, 20% or more, 30% or more, 40% or more, 50% or more, or 60% or more of the total length of the exhaust gas flow paths, and may be 60% or less, 50% or less, 40% or less, 30% or less, 20% or less, or 10% or less of the total length of the exhaust gas flow paths. The length of the inlet-side part of the honeycomb substrate may be, for example, 10 mm or more, and may be, for example, 30 mm or less. When the total length of the gas flow paths is 80 mm, the 10 mm length of the inlet-side part corresponds to 12.5% of the total length of the gas flow paths, and the 30 mm length of the inlet-side part corresponds to 37.5% of the total length of the gas flow paths.

The specific noble metal of the noble metal-enriched surface part may be one selected from the group consisting of platinum, palladium, and rhodium, and may be platinum or palladium.

The present inventors have discovered that by carrying a large quantity of catalyst noble metal on the inlet side of the exhaust gas, the exhaust gas purification device of the present invention becomes more advantageous. When a large quantity of catalyst noble metal is carried on the inlet side of the exhaust gas, the warm-up performance of the exhaust gas purification device of the present invention can be greatly improved. This is because the temperature of the exhaust gas purification device rises from the inlet side during use, and since a large quantity of catalyst noble metal is present on the inlet side, the exhaust gas can react with the catalyst noble metal at a relatively high temperature, even in the early stages of operation, and the exhaust gas can be purified more effectively.

Thus, it is preferable that a large quantity of the catalyst noble metal be carried by the inlet-side part of the honeycomb substrate, and it is preferable that the quantity of the catalyst noble metal carried by the inlet-side part be greater than the quantity of the catalyst noble metal carried by the main part.

For example, the quantity of the catalyst noble metal carried by the inlet-side part may be 1.1 times or more, 1.3 times or more, 1.5 times or more, 2.0 times or more, 3.0 times or more, or 5.0 times or more, and 10 times or less, 5.0 times or less, 3.0 times or less, or 2.0 times or less the quantity of the catalyst noble metal carried by the main part.

It was discovered that it is particularly effective to carry the catalyst noble metal deeper in the inlet-side part of the exhaust gas purification device than in the main part. This is because the exhaust gas flowing through the inlet-side part of the exhaust gas purification device contains more exhaust gas components to be purified, while the exhaust gas flowing through the main part contains fewer exhaust gas components to be purified, and thus, in the inlet-side part, the catalyst noble metal is carried through to the interior of the porous wall of the honeycomb substrate to thoroughly purify the exhaust gas and the remaining exhaust gas is purified in the noble metal-enriched surface part which is present at least in the main part, which is advantageous from the viewpoint of noble metal distribution.

Thus, it is preferable that the 50 mass % noble metal carrying depth of the inlet-side part be greater than the 50 mass % noble metal carrying depth of the main part, and for example, the 50 mass % noble metal carrying depth of the inlet-side part may be 1.05 times, 1.1 times, 1.2 times, 1.3 times, 1.5 times, or 2.0 times, and may be 3.0 times or less, 2.5 times or less, 2.0 times or less, or 1.5 times or less the 50 mass % noble metal carrying depth of the main part.

In the inlet-side part of the exhaust gas purification device, the catalyst noble metal, which is carried to positions deeper than in the main part, may be one selected from the group consisting of platinum, palladium, and rhodium, and may be platinum or palladium. The catalyst noble metal which is carried to positions deeper in the inlet-side part of the exhaust gas purification device than in the main part may be of the same type as the specific noble metal in the noble metal-enriched surface part of the substrate or may be of a different type.

However, from the viewpoint of carrying the catalyst noble metal through to the interior of the porous wall of the honeycomb substrate in the inlet-side part to thoroughly purify the exhaust gas and purifying the remaining exhaust gas with the noble metal-enriched surface part, the catalyst noble metal which is carried to positions deeper in the inlet-side part of the exhaust gas purification device than in the main part may be of the same type as the specific noble metal in the noble metal-enriched surface part.

Thus, the quantity of the specific noble metal carried by the inlet-side part of the honeycomb structure may be greater than the quantity of the specific noble metal carried by the main part, and in the inlet-side part of the honeycomb substrate, the 50 mass % noble metal carrying depth of the specific noble metal may be greater than the 50 mass % noble metal carrying depth of the specific noble metal in the main part.

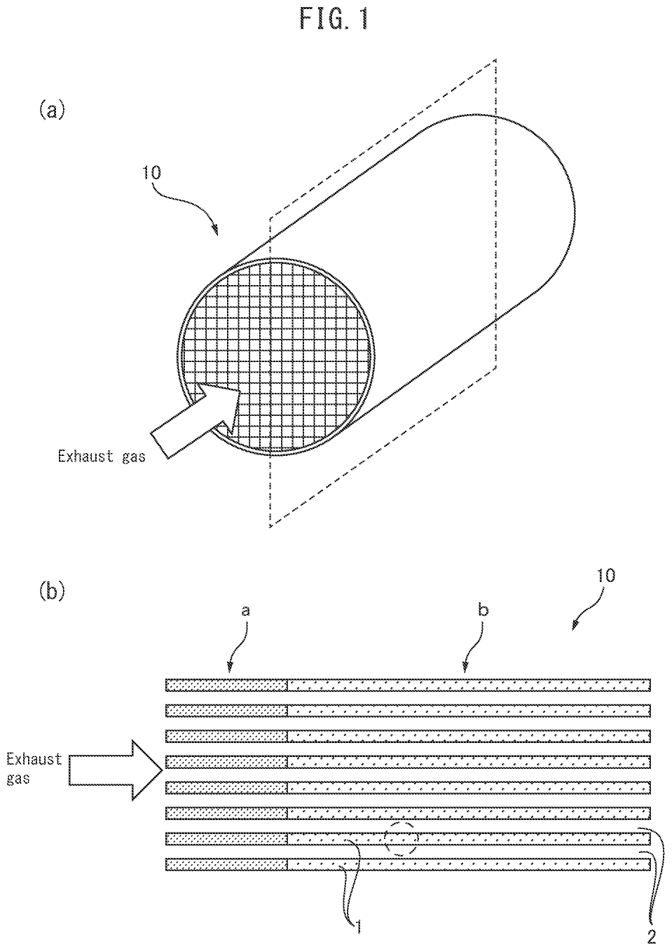

FIG. 1(a) is a perspective view schematically illustrating an aspect of the exhaust gas purification device of the present invention, and FIG. 1(b) is a cross-sectional side view schematically illustrating an aspect of the exhaust gas purification device of the present invention. The exhaust gas purification device 10 comprises a honeycomb substrate having a plurality of exhaust gas flow paths 2 separated by a porous wall 1 of the honeycomb substrate. The portion from the inlet side of the exhaust gas flow paths 2 of the honeycomb substrate to, for example, ¼ or less of the total length thereof can serve as the inlet-side part a, and the portion excluding this portion can serve as the main part b of the honeycomb substrate. The quantity of the catalyst noble metal carried by the inlet-side part a, for example, platinum and/or palladium, and in particular, platinum or palladium, is preferably greater than the quantity of the catalyst noble metal carried by the main part b, for example, platinum and/or palladium, in particular, platinum or palladium. An enlarged view of the portion indicated by the dashed circle in FIG. 1(b) is shown in FIG. 2.

### <Honeycomb Substrate>

The honeycomb substrate used in the exhaust gas purification device of the present invention includes ceria-zirconia composite oxide particles as a constituent material. Specifically, such a honeycomb substrate differs from honeycomb substrates composed of cordierite as currently used, and is, for example, a honeycomb substrate as disclosed in Patent Literature 1 to 3.

For example, the honeycomb substrate may include 20 mass % or more, 30 mass % or more, 40 mass % or more, 50 mass % or more, 60 mass % or more, or 70 mass % or more, of the ceria-zirconia composite oxide particles, and may include 95 mass % or less, 90 mass % or less, 80 mass % or less, 70 mass % or less, 60 mass % or less, 50 mass % or less, or 40 mass % or less of the ceria-zirconia composite oxide particles. For example, the honeycomb substrate may include 30 mass % to 95 mass % or 50 mass % to 90 mass % of the ceria-zirconia composite oxide particles. The ceria-zirconia composite oxide particles are particles used as an oxygen storage material in the field of exhaust gas purification devices, and may be particles of a solid solution of ceria and zirconia. Rare earth elements such as lanthanum (La) and yttrium (Y) may be further dissolved in this solid solution.

The honeycomb substrate may contain carrier particles such as those used as carriers of noble metal catalyst particles in the prior art, such as alumina particles, and may further contain an inorganic binder such as alumina, zirconia, yttria, titania, or silica. The honeycomb substrate may contain θ-phase alumina particles as described in Patent Literature 1 and/or tungsten composite oxide particles as described in Patent Literature 2.

The honeycomb substrate has a plurality of exhaust gas flow paths separated by a porous wall. The honeycomb substrate may be a so-called “straight flow” honeycomb substrate in which the exhaust gas flow paths have a plurality of cells arranged in a grid shape in which each flow path is arranged linearly and in parallel, and the plurality of cells are open to both the inlet side and the outlet side. The honeycomb substrate may have a so-called “wall-flow” honeycomb substrate which comprise a plurality of cells partitioned by porous partition walls, the plurality of cells are composed of an inlet-side cells having an inlet side which is open and an outlet side which is sealed, and outlet-side cells having an outlet side which is open and an inlet side which is sealed.

The number of exhaust gas flow paths is referred to as the “cell number”, which is represented by the number of exhaust gas flow paths per square inch. The cell number of the honeycomb substrate may be 30 cells/inch² or more, 50 cells/inch² or more, 100 cells/inch² or more, 200 cells/inch² or more, 300 cells/inch² or more, 400 cells/inch² or more, 600 cells/inch² or more, or 800 cells/inch² or more, and may be 1200 cells/inch² or less, 1000 cells/inch² or less, 800 cells/inch² or less, 500 cells/inch² or less, or 300 cells/inch² or less. For example, the cell number of the honeycomb substrate may be 100 cells/inch² to 1200 cells/inch², or 200 cells/inch² to 1000 cells/inch².

The length of the exhaust gas flow paths of the honeycomb substrate or the length of the honeycomb substrate may be 50 mm or more, 60 mm or more, 80 mm or more, 100 mm or more, 120 mm or more, or 150 mm or more, and may be 300 mm or less, 250 mm or less, 200 mm or less, 150 mm or less, or 120 mm or less. For example, the length of the exhaust gas flow paths of the honeycomb substrate or the length of the honeycomb substrate may be 50 mm to 300 mm, or 60 mm to 200 mm.

The cross-sectional area of the honeycomb substrate may be 60 cm² or more, 80 cm² or more, 100 cm² or more, 120 cm² or more, or 150 cm² or more, and may be 300 cm² or less, 250 cm² or less, 200 cm² or less, 150 cm² or less, or 120 cm² or less. For example, the cross-sectional area of the honeycomb substrate may be 60 cm² to 300 cm², or 100 cm² to 250 cm².

The capacity of the honeycomb substrate may be 500 cc or more, 600 cc or more, 800 cc or more, 1000 cc or more, or 1500 cc or more, and may be 3000 cc or less, 2500 cc or less, 2000 cc or less, 1500 cc or less, or 1200 cc or less. For example, the capacity of the honeycomb substrate may be 500 cc to 3000 cc, or 600 cc to 1500 cc.

The thickness of the porous walls of the honeycomb substrate is not particularly limited, and may be 50 μm or more, 70 μm or more, 80 μm or more, 100 μm or more, 120 μm or more, or 150 μm or more, and may be 300 μm or less, 200 μm or less, 150 μm or less, or 120 μm or less. For example, the thickness of the porous walls of the honeycomb substrate may be 50 μm to 300 μm, or 70 μm to 150 μm.

The porosity of the honeycomb substrate is not particularly limited, and may be, for example, 30% or more, 40% or more, 50% or more, or 60% more, and may be 80% or less, 70% or less, or 60% or less. The porosity can be determined from the ratio of the weight of the porous body to the theoretical weight of the solid body of the material of the porous body. For example, the porosity of the honeycomb substrate may be 30% to 70%, or 40% to 60%.

The specific surface area of the honeycomb substrate is not particularly limited, and may be, for example, 10 m²/g or more, 20 m²/g or more, or 30 m²/g or more, and may be 200 m²/g or less, 100 m²/g or less, or 50 m²/g or less. The specific surface area can be determined from the BET flow method with a Macsorb™ HM model-1230 (Mountech Co., Ltd.) using the nitrogen adsorption method. For example, the specific surface area of the honeycomb substrate may be 10 m²/g to 200 m²/g, or 20 m²/g to 100 m²/g.

### <Catalyst Noble Metal Particles>

The catalyst noble metal of the exhaust gas purification device of the present invention may be, for example, one or more selected from the group consisting of platinum, palladium, and rhodium.

The exhaust gas purification device of the present invention may comprise, as catalyst noble metal particles, for example, at least platinum and/or palladium carried by a honeycomb substrate. The platinum and/or palladium may be carried by the honeycomb substrate, based on the capacity of the entire honeycomb substrate, at 0.10 g/L or more, 0.30 g/L or more, 0.50 g/L or more, 0.80 g/L or more, 1.00 g/L or more, 1.50 g/L or more, 2.00 g/L or more, or 3.00 g/L or more, and may be carried at 6.00 g/L or less, 4.00 g/L or less, 3.00 g/L or less, 2.00 g/L or less, 1.50 g/L or less, or 1.20 g/L or less, or 1.00 g/L or less. For example, the platinum and/or palladium may be carried at 0.30 g/L to 6.00 g/L, or 0.50 g/L to 3.00 g/L, based on the capacity of the entire honeycomb substrate.

The platinum and/or palladium may be carried on the inlet-side part of the honeycomb substrate, based on the capacity of the inlet-side part, at 0.80 g/L or more, 1.00 g/L or more, 1.50 g/L or more, 2.00 g/L or more, or 3.00 g/L or more, and may be carried at 8.00 g/L or less, 6.00 g/L or less, 5.00 g/L or less, 4.00 g/L or less, or 3.00 g/L or less. For example, the platinum and/or palladium may be carried on the inlet-side part of the honeycomb substrate, based on the capacity of the inlet-side part, at 1.00 g/L to 8.00 g/L, or 2.00 g/L to 5.00 g/L. The platinum and/or palladium may be carried by the main part of the honeycomb substrate, based on the capacity of the main part, at 0.50 g/L or more, 0.30 g/L or more, 0.50 g/L or more, 0.80 g/L or more, 1.00 g/L or more, 1.50 g/L or more, 2.00 g/L or more, or 3.00 g/L or more, and may be carried at 6.00 g/L or less, 4.00 g/L or less, 3.00 g/L or less, 2.00 g/L or less, 1.50 g/L or less, 1.20 g/L or less, or 1.00 g/L or less. For example, the platinum and/or palladium may be carried by the main part of the honeycomb substrate at 0.30 g/L to 6.00 g/L, or 0.50 g/L to 3.00 g/L, based on the capacity of the main part.

The exhaust gas purification device of the present invention can further comprise rhodium as catalyst noble metal particles. The rhodium may be carried, based on the capacity of the entire honeycomb substrate, at 0.10 g/L or more, 0.30 g/L or more, 0.50 g/L or more, 0.80 g/L or more, or 1.00 g/L or more, and may be carried at 1.50 g/L or less, 1.20 g/L or less, 1.00 g/L or less, 0.80 g/L or less, or 0.50 g/L or less. For example, the rhodium may be carried at 0.10 g/L to 1.50 g/L, or 0.30 g/L to 1.00 g/L, based on the capacity of the entire honeycomb substrate.

### <Catalyst Layer>

It is preferable that at least a part of the exhaust gas purification device of the present invention not have a catalyst layer such as that formed on a cordierite-based honeycomb substrate in the prior art. Thus, in the exhaust gas purification device of the present invention, a catalyst layer having a composition substantially different from that of the honeycomb substrate is not present in at least a part of the exhaust gas flow path of the honeycomb substrate.

### <<Method for Production of Exhaust Gas Purification Device>>

The method for the production of the exhaust gas purification device of the present invention comprises: supplying a solution containing salts of one or more catalyst noble metals and a thickening agent from one open side of a honeycomb substrate having a plurality of exhaust gas flow paths separated by a porous wall; suctioning the supplied solution from an opening side of the honeycomb substrate opposite the side to which the solution was supplied and/or pumping the supplied solution from the opening side of the honeycomb substrate to which the solution was supplied; and drying and/or firing the honeycomb substrate, wherein the solution has a viscosity of 10 to 400 mPa at a shear rate of 380 s⁻¹. The method for the production of the exhaust gas purification device of the present invention may comprise, for example, supplying a solution containing salts of catalyst noble metals and a thickening agent from an inlet side of a honeycomb substrate; suctioning the supplied solution from an outlet side of the honeycomb substrate and/or pumping the supplied solution from the inlet side of the honeycomb substrate; and drying and/or firing the honeycomb substrate.

By adding a thickening agent to the solution containing a salt of the catalyst noble metal, the viscosity of the solution can be adjusted to reduce the 50 mass % noble metal carrying depth, i.e., the catalyst noble metal can be concentrated on the surface side of the porous wall. The viscosity of the solution at a shear rate of 380 s⁻¹ may be 10 mPa or more, 50 mPa or more, or 100 mPa or more, and may be 400 mPa or less, 300 mPa or less, or 200 mPa or less, when measured using a TV-33 viscosity meter (manufactured by Toki Sangyo Co., Ltd.) at 25° C. by changing the rotation speed from 1 to 100 rpm, and using a 1° 34′×R24 conical flat plate. The viscosity of the solution at a shear rate of 4 s⁻¹ may be 100 mPa or more, 500 mPa or more, 1000 mPa or more, 3000 mPa or more, or 5000 mPa or more, and may be 30000 mPa or less, 10000 mPa or less, 7000 mPa or less, 5000 mPa or less, or 3000 mPa or less, when measured at room temperature using a TVE-30H viscometer (manufactured by Toki Sangyo Co., Ltd.).

Examples of the salts of platinum and/or palladium, among the catalyst noble metals, include strong acid salts of platinum and/or palladium, and in particular, nitrates or sulfates of platinum and/or palladium. When a salt of rhodium is contained in the solution, a similar salt can be used. The solution may not contain carrier particles of an inorganic oxide such as alumina, silica, or a ceria-zirconia composite oxide, which have been used as the carrier of the catalyst noble metal in the prior art.

Examples of the thickening agent include water-soluble polymers such as hydroxyl ethyl cellulose, carboxy methylcellulose, methylcellulose, and polyvinyl alcohol.

Regarding the method for applying the solution containing a salt of a catalyst noble metal and a thickening agent onto a honeycomb substrate, refer to Patent Literature 4.

When drying the honeycomb substrate, the drying temperature may be, for example, 50° C. or higher, 100° C. or higher, or 150° C. or higher, and may be 200° C. or lower, or 150° C. or lower. For example, the drying temperature may be 100° C. to 200° C. The drying time may be 1 hour or more, 2 hours or more, or 5 hours or more, and may be 10 hours or less, or 5 hours or less. For example, the drying time may be 1 hour to 10 hours. When firing the honeycomb substrate, the firing temperature may be, for example, 400° C. or higher, 500° C. or higher, 550° C. or higher, or 600° C. or higher, and may be 1000° C. or lower, 800° C. or lower, or 700° C. or lower. For example, the firing temperature may be 400° C. to 1000° C., or 500° C. to 800° C. The firing time may be 30 minutes or more, 1 hour or more, 2 hours or more, or 4 hours or more, and may be 12 hours or less, 10 hours or less, or 8 hours or less. For example, the firing time may be 30 minutes to 12 hours, or 1 hour to 8 hours.

The exhaust gas purification device obtained by the method of the production of an exhaust gas purification device of the present invention may be the exhaust gas purification device of the present invention described above. Regarding the features of the method for the production of an exhaust gas purification device of the present invention, refer to the features described above with regarding the exhaust gas purification device of the present invention.

The method for the production of an exhaust gas purification device of the present invention may further include immersing the honeycomb substrate in a solution containing a salt of a catalyst noble metal so that at least a part of the inlet-side part of a predetermined length is immersed from the inlets of the exhaust gas flow paths of the honeycomb substrate, then removing the honeycomb substrate from the solution, and drying and/or firing the honeycomb substrate. In this case, a part or all of the inlet-side part may be immersed in the solution so that the main part excluding the inlet-side part is not immersed in the solution, or the inlet-side part and the part of the main part excluding the inlet-side part may be immersed in the solution.

By including this step, more catalyst noble metal can be carried by the inlet-side part of the honeycomb substrate than by the main part. Since the honeycomb substrate is immersed in the solution to carry the catalyst noble metal, only the 50 mass % noble metal carrying depth at the inlet-side part can be increased. As a result, high warm-up performance can be imparted to the obtained exhaust gas purification device, and the distribution of the noble metal can be made efficient. The solution used by this step may be the same as the solution used in the application described above, or may be a solution having a composition obtained by removing the thickening agent from the solution used in the application described above.

This step may be carried out after the step of drying and/or firing the honeycomb substrate, and may be carried out prior to the step of drying and/or firing. If this step is carried out after the step of drying and/or firing the honeycomb substrate, this step may be followed by a step of further drying and/or firing the honeycomb substrate, as described above.

The present invention will be further specifically described by the following Examples, but the present invention is not limited thereto.

### EXAMPLES

### Production Examples

### Example 1

A ceria-zirconia-based (CZ-based) monolithic honeycomb substrate having a capacity of 860 cc, a substrate length of 80 mm, a diameter of 117 mm, a cell number of 400 cells/inch, and a wall thickness of 120 μm, and containing a ceria-zirconia composite oxide having a weight of 21% in terms of ceria and a weight of 25% in terms of zirconia was used as a substrate. The cell shape was square. A coating solution was poured into this honeycomb substrate by the method described in Patent Literature 4, and unnecessary solution was blown off using a blower. The coating solution contained, in pure water, palladium nitrate in a quantity of 0.12 wt % in terms of palladium (Pd), rhodium nitrate in a quantity of 0.06 wt % in terms of rhodium (Rh), and a thickening agent (hydroxyethyl cellulose, Daicel Corporation), and the viscosity at a shear rate of 380 s measured using a TV-33 viscosity meter (manufactured by Toki Sangyo Co., Ltd.) at 25° C. by changing the rotation speed from 1 to 100 rpm, and using a 1° 34′×R24 conical flat plate was 300 mPa. Thereafter, it was dried for 2 hours in a dryer at 120° C., and then fired for 2 hours in an electric furnace at 500° C. At that time, the quantities of palladium and rhodium carried on the substrate were 0.51 g/L and 0.24 g/L, respectively.

Thereafter, in order to further carry an additional 1.1 g of palladium, as the quantity of palladium per honeycomb substrate, at positions up to 20 mm from the inlet side of the exhaust gas flow paths of the honeycomb substrate, the front side of the honeycomb substrate was immersed and left in a palladium nitrate aqueous solution. Thereafter, the honeycomb substrate was removed from the solution, and after blowing off the unnecessary solution using a blower, dried for 2 hours with a dryer at 120° C., and then fired for 2 hours in an electric furnace at 500° C. As a result, the exhaust gas purification device of Example 1 was obtained.

### Example 2

The exhaust gas purification device of Example 2 was obtained in the same manner as in Example 1, except that the position from the inlet side of the exhaust gas flow paths of the honeycomb substrate up to which the 1.1 g of palladium, as the quantity of palladium per honeycomb substrate, was further carried was 32 mm.

### Example 3

The exhaust gas purification device of Example 3 was obtained in the same manner as in Example 1, except that the quantity of the thickening agent of the coating solution was increased so as to obtain a viscosity of 200 mPa at a shear rate of 380 s⁻¹.

### Comparative Example 1

A cordierite-based (Co-based) monolithic honeycomb substrate having a capacity of 875 cc, a diameter of 118 mm, 600 square cells, and a wall thickness of 3 mil was used as the substrate. A lower layer slurry containing palladium nitrate, lanthanum oxide-composite alumina, a ceria-zirconia composite oxide, barium nitrate, and an alumina sol-based binder was prepared, the lower layer slurry was poured into the honeycomb substrate by the method described in Patent Literature 4, and unnecessary slurry was blown off using a blower. Thereafter, it was dried for 2 hours with a dryer at 120° C., and then fired for 2 hours in an electric furnace at 500° C., to form a lower layer on the honeycomb substrate. This lower layer contained 0.7 g/L of palladium, 50 g/L of alumina, 50 g/L of ceria-zirconia composite oxide, and 5 g/L barium sulfate, as masses per unit capacity of the honeycomb substrate.

Next, an upper layer slurry containing rhodium nitrate, lanthanum oxide-composite alumina, a ceria-zirconia composite oxide, barium nitrate, and an alumina sol-based binder was prepared, and an upper layer was formed on the lower layer in the same manner as in the case of the formation of the lower layer. The upper layer had 0.2 g/L of rhodium, 55 g/L of alumina, and 50 g/L of ceria-zirconia composite oxide as masses per unit capacity of the honeycomb substrate. As a result, the exhaust gas purification device of Comparative Example 1 was obtained.

### Comparative Example 2

Palladium and rhodium were carried by the honeycomb substrate containing ceria-zirconia composite oxide as a constituent material used in Example 1 at the same weight as used in the method described in Patent Literature 1 and Example 1. Specifically, palladium and rhodium were carried by the honeycomb substrate by immersing the substrate in an aqueous solution in which rhodium nitrate and rhodium chloride were dispersed in necessary quantities and allowing it to stand for a predetermined time.

### <<Evaluation Methods>>

### <Palladium (Pd) 50% Carrying Depth>

There was evaluated the 50 mass % noble metal carrying depth from the surface in which, out of the total quantity of palladium present in the depth direction from the surface of the wall of the substrate to the center of the wall, 50 mass % of palladium was present. For example, in Table 1, the 50 mass % noble metal carrying depth of Example 1 of the wall having a thickness of 120 μm was 20 μm, which means that 50% of the palladium was carried in a range of 20 μm from the surface of the wall, and the remaining 50% of the palladium was carried in a range of greater than 20 μm and up to 60 μm from the surface. In Table 1, the 50 mass % noble metal carrying depth with respect to a distance (60 μm) from the surface of the porous wall to the center of the porous wall, and the 50 mass % noble metal carrying depth with respect to a thickness (120 μm) of the porous wall are also shown together.

In the analysis of the carrying depth, the exhaust gas purifying catalyst was embedded in a resin and cut, and the porous wall thereof was measured using an FE-EPMA (JXA-8530F, manufactured by JEOL, Ltd.). Specifically, the distribution of palladium was measured at a field magnification of 400 times, a minimum beam diameter, an acceleration voltage of 20 kV, an irradiation current of 100 nA, a collection time of 50 seconds, and a pixel count of 256×256, whereby the 50 mass % noble metal carrying depth as described above was determined.

### (Warm-Up Performance and HC Purification Rate)

The exhaust gas purification device of each Example was mounted on an exhaust system of a V-8 engine, and the flow of exhaust gases under stoichiometric and lean atmospheres at constant intervals was repeated over a period of 50 hours at a catalyst bed temperature of 950° C.

Thereafter, each exhaust gas purification device was remounted on the exhaust system of a 4-cylinder engine, and exhaust gas having an air-fuel ratio (A/F) of 14.4 and an exhaust gas mass flow rate of Ga=19 g/s was supplied to evaluate the arrival time to reach a 50% hydrocarbon (HC) purification rate (=warm-up performance (˜500° C.)).

Exhaust gas having an air-fuel ratio (A/F) of 14.2 and an exhaust gas mass flow rate of Ga=24 g/s was supplied to measure the hydrocarbon (HC) purification rate at a catalyst bed temperature of 500° C.

### <<Results>>

The results thereof are shown in the following table.

TABLE 1

| | | | Pd 50% | | | | | |
|---|---|---|---|---|---|---|---|---|
| | | | Carrying Depth | | | | | |
| | | | | Distance | | | | |
| | | | | from | | | | |
| | | | | Surface to | Wall | Inlet-Side | 50% | |
| | | Catalyst | | Center | Thickness | Pd Carrying | Purification | HC |
| | | Layer | | Reference | Reference | Length | Arrival Time | Purification |
| | Substrate | [g/L] | [μm] | [%] | [%] | [mm] | [S] | [%] |
| Ex 1 | CZ- | 0 | 20 | 33.4 | 16.7 | 20 | 84.6 | 78 |
| | based | | | | | | | |
| Ex 2 | CZ- | 0 | 20 | 33.4 | 16.7 | 32 | 84.2 | 78 |
| | based | | | | | | | |
| Ex 3 | CZ- | 0 | 15 | 25 | 12.5 | 20 | 82.0 | 80 |
| | based | | | | | | | |
| Comp Ex | Co-based | 230 | — | — | — | 20 | 91.6 | 70 |
| 1 | | | | | | | | |
| Comp Ex | CZ- | 0 | 30 | 50 | 25 | N/A | 89.4 | 73 |
| 2 | based | | | | | | | |

### REFERENCE SIGNS LIST

1 porous wall
2 exhaust gas flow path
a inlet-side part
b main part
10 exhaust gas purification device

1. An exhaust gas purification device comprising a honeycomb substrate having a plurality of exhaust gas flow paths separated by a porous wall, and one or more catalyst noble metals which are carried by the honeycomb substrate, wherein
the honeycomb substrate includes ceria-zirconia composite oxide particles as a constituent material,
the catalyst noble metals are selected from the group consisting of platinum, palladium, and rhodium,
the honeycomb substrate has:
a noble metal-enriched surface part in which a 50 mass % noble metal carrying depth of a specific noble metal, which is one of the one or more catalyst noble metals, is less than 50% of the distance from a surface of the porous wall to a center of an interior of the porous wall, and
the 50 mass % noble metal carrying depth is a depth in which 50 mass % of the specific noble metal is carried based on a quantity of the specific noble metal carried from the surface of the porous wall to the center of the interior of the porous wall.

2. The exhaust gas purification device according to claim 1, wherein
the specific noble metal is platinum or palladium.

3. The exhaust gas purification device according to claim 2, wherein
the specific noble metal is platinum or palladium, and
the catalyst noble metals include rhodium.

4. The exhaust gas purification device according to claim 1, wherein the honeycomb substrate is constituted by an inlet-side part which is 60% or less of a total length of the honeycomb substrate from an inlet side of the exhaust gas flow path, and a main part constituting the remainder of the honeycomb substrate, and the noble metal-enriched surface part is present at least in the main part.

5. The exhaust gas purification device according to claim 4, wherein a length of the inlet-side part constituting the honeycomb substrate is 10% or more of the total length of the honeycomb substrate.

6. The exhaust gas purification device according to claim 1, wherein the honeycomb substrate is constituted by an inlet-side part which is 30 mm or less from an inlet side of the exhaust gas flow path and a main part constituting the remainder of the honeycomb substrate, and the noble metal-enriched surface part is present at least in the main part.

7. The exhaust gas purification device according to claim 6, wherein a length of the inlet-side part constituting the honeycomb substrate is 10 mm or more.

8. The exhaust gas purification device according to claim 4, wherein a quantity of the specific noble metal carried by the inlet-side part of the honeycomb substrate is greater than a quantity of the specific noble metal carried by the main part.

9. The exhaust gas purification device according to claim 4, wherein in the inlet-side part of the honeycomb substrate, the 50 mass % noble metal carrying depth of the specific noble metal is greater than the 50 mass % noble metal carrying depth of the specific noble metal of the main part.

10. The exhaust gas purification device according to claim 1, wherein a porosity of the honeycomb substrate is 30% to 70%.

11. The exhaust gas purification device according to claim 1, wherein at least a part of the exhaust gas flow path does not have a catalyst layer.

12. A method for the production of an exhaust gas purification device, comprising at least the following (a) to (c):
(a) supplying a solution containing salts of one or more catalyst noble metals and a thickening agent from one open side of a honeycomb substrate having a plurality of exhaust gas flow paths separated by a porous wall, the solution having a viscosity of 10 to 400 mPa at a shear rate of 380 s⁻¹ and the catalyst noble metals being selected from the group consisting of platinum, palladium, and rhodium;
(b) suctioning the supplied solution from an opening side of the honeycomb substrate opposite the side to which the solution was supplied and/or pumping the supplied solution from the opening side of the honeycomb substrate to which the solution was supplied; and
(c) drying and/or firing the honeycomb substrate.

13. The method according to claim 12, further comprising the following (d):
(d) immersing the honeycomb substrate in a solution containing salts of the catalyst noble metals so that at least a part of an inlet-side part which is 30 mm or less of a total length from an inlet of the exhaust gas flow path of the honeycomb substrate is immersed, and subsequently drying and/or firing the honeycomb substrate, whereby a quantity of the catalyst noble metal carried by the inlet-side part is greater than a quantity of the catalyst noble metal carried by a main part excluding the inlet-side part.

14. The exhaust gas purification device according to claim 2, wherein the honeycomb substrate is constituted by an inlet-side part which is 60% or less of a total length of the honeycomb substrate from an inlet side of the exhaust gas flow path, and a main part constituting the remainder of the honeycomb substrate, and the noble metal-enriched surface part is present at least in the main part.

15. The exhaust gas purification device according to claim 14, wherein a length of the inlet-side part constituting the honeycomb substrate is 10% or more of the total length of the honeycomb substrate.

16. The exhaust gas purification device according to claim 14, wherein in the inlet-side part of the honeycomb substrate, the 50 mass % noble metal carrying depth of the specific noble metal is greater than the 50 mass % noble metal carrying depth of the specific noble metal of the main part.

17. The exhaust gas purification device according to claim 3, wherein the honeycomb substrate is constituted by an inlet-side part which is 60% or less of a total length of the honeycomb substrate from an inlet side of the exhaust gas flow path, and a main part constituting the remainder of the honeycomb substrate, and the noble metal-enriched surface part is present at least in the main part.

18. The exhaust gas purification device according to claim 17, wherein a length of the inlet-side part constituting the honeycomb substrate is 10% or more of the total length of the honeycomb substrate.

19. The exhaust gas purification device according to claim 17, wherein in the inlet-side part of the honeycomb substrate, the 50 mass % noble metal carrying depth of the specific noble metal is greater than the 50 mass % noble metal carrying depth of the specific noble metal of the main part.
